(19) United States
(12) Patent Application Publication
(10) Pub. No.: US 2023/0162248 A1
(43) Pub. Date: May 25, 2023

(54) SYSTEM, METHOD AND COMPUTER PROGRAM PRODUCT FOR DISPENSING DIGITAL BUSINESS CONCIERGE SERVICES

(71) Applicant: 7960786 CANADA INC., Montréal (CA)

(72) Inventor: Daniel Forman, Montréal (CA)

(21) Appl. No.: 17/530,645

(22) Filed: Nov. 19, 2021

(51) Int. Cl. G06Q 30/06

(52) U.S. Cl. CPC G06Q 30/0601

(57) ABSTRACT

The method of dispensing digital business concierge services on a client computer system comprises receiving from a server computer system a client identifier on the client computer system and persistently storing the client identifier at the client computer system. Then, when a download condition is met, information data elements are downloaded from the server computer system to the client computer system, each associated to the client identifier. Discrete information display elements are displayed on the client computer system, each representing at least one of the number of information data elements, to allow the user browse them. At least some of the information display elements comprise respective service display elements. The user may upload a service request from the client computer system to the server computer system to order a service associated to one of the service display elements, by activating a service request command displayed on client computer system and associated to the service display element; which will then send to the server system the service request for the service along with the client identifier, the client identifier identifying account information previously supplied by the user of the client computer system wherein the user does not need to log in to the server system when ordering the service.

### FIELD OF THE INVENTION

The present invention relates to the field of digital concierge services, and more particularly to dispensing digital concierge services on a computer system, specifically in the field of managed digital marketing services.

### BACKGROUND OF THE INVENTION

Buying services online is well known. There is however a need to allow a simple dispensation of business services, specifically in the field of managed digital marketing services, where a diversity of services are offered to a user of a computer system.

### SUMMARY OF THE INVENTION

The present invention relates to a method of dispensing digital business concierge services on a client computer system, comprising:
receiving from a server computer system a client identifier on the client computer system;
persistently storing the client identifier at the client computer system; and
when a download condition is met:
   downloading information data elements from the server computer system to the client computer system, each associated to the client identifier;
   displaying on a video display of the client computer system discrete information display elements each representing at least one of said number of information data elements;
   allowing a user of the client computer system to browse through the information display elements;
   at least some of the information display elements comprising respective service display elements; and
   for each said service display element displayed through said information display elements, allowing the user the upload of a service request from the client computer system to the server computer system to order a service associated to the service display element, triggering the upload of a service request comprising:
      activating a service request command displayed on client computer system and associated to the service display element; and
      sending to the server system the service request for the service along with the client identifier, the client identifier identifying account information previously supplied by the user of the client computer system wherein the user does not need to log in to the server system when ordering the service.

In one embodiment, the step of allowing a user of the client computer system to browse through the display elements, comprises the user swiping a touch screen of the client computer system with a finger to switch between successive information display elements that are individually and successively displayed on the touch screen.

In one embodiment, said download condition is a download trigger programmed at determined time intervals on said client computer system, said download trigger initiating the download of said information data elements to said client computer system.

In another embodiment, said download condition is a punctual user-triggered request on said client computer system that initiates the download of said information data elements to said client computer system.

In another embodiment, said download condition is an administrator-triggered instruction on said server computer system by an administrator of said server computer system, that initiates the download of said information data elements from the server computer system to said client computer system.

In one embodiment, the client computer system is one of a portable computer device and a personal desktop computer.

In one embodiment, the client computer system uses a web-based interface to communicate with the server computer system.

In another embodiment, the client computer system uses a software-based application interface to communicate with the server computer system.

In another embodiment, the discrete display elements are each in the form of card images wherein a corresponding information element is displayed, with swiping a touch screen of the client computer system with a finger to switch between successive information display elements comprising switching from one card image to another.

In another embodiment, a client account associated with the client identifier is created on the server computer system, and credits may be purchased by the client and associated to their client account, such that the order of a service associated with the service display element entails debiting a determined number of credits from the client account.

In another embodiment, the determined number of credits for the service being ordered is displayed on the associated service display element.

The present invention also relates to a client computer system comprising a processor programmed to initiate executable operations for dispensing digital business concierge services thereon, the executable operations comprising:
receiving from a server computer system a client identifier on the client computer system;
persistently storing the client identifier at the client computer system; and
when a download condition is met:
   downloading from the server computer system a number of information data elements, with each of the number of information data elements being associated to the client identifier;
   displaying on a video display of the client computer system discrete information display elements each representing at least one of said number of information data elements;
   allowing a user of the client computer system to browse through the information display elements; and
   at least one of the information display elements comprising a service display element, said service display element allowing the user to trigger the upload of a user request from the client computer system to the server computer system to order a service associated to the service display element;
wherein the step of allowing the user to trigger the upload of a user request from the client computer system to the server computer system comprises activating a command displayed on the service display element, sending to the server system the request for the service along with the client identifier, the client identifier identifying account information previously supplied by the user of the client computer system wherein the user does not need to log in to the server system when ordering the service.

The present invention further relates to a computer program product comprising a computer readable memory storing computer executable instructions thereon that when executed by a client computer system for dispensing digital business concierge services, perform the steps of:
receiving from a server computer system a client identifier on the client computer system;
persistently storing the client identifier at the client computer system; and
when a download condition is met:
   downloading from the server computer system a number of information data elements, with each of the number of information data elements being associated to the client identifier;
   displaying on a video display of the client computer system discrete information display elements each representing at least one of said number of information data elements;
   allowing a user of the client computer system to browse through the information display elements; and
   at least one of the information display elements comprising a service display element, said service display element allowing the user to trigger the upload of a user request from the client computer system to the server computer system to order a service associated to the service display element;

wherein the step of allowing the user to trigger the upload of a user request from the client computer system to the server computer system comprises activating a command displayed on the service display element, sending to the server system the request for the service along with the client identifier, the client identifier identifying account information previously supplied by the user of the client computer system wherein the user does not need to log in to the server system when ordering the service.

### DESCRIPTION OF THE DRAWINGS

In the annexed drawings:

FIG. 1 is schematic view of a computer network environment for enabling the method of dispensing digital business concierge services on a client computer system according to the present invention;

FIG. 2 is a block diagram showing the steps of the method for dispensing digital business concierge services according to the present invention;

FIGS. 3-5 are front elevations schematically showing a client computer system in the form of a cellular phone on which information display elements are displayed, and sequentially showing how the user may browse between successive information display elements with their finger; and

FIG. 6 shows four information display elements.

### DETAILED DESCRIPTION OF THE EMBODIMENTS

As will be appreciated by one skilled in the art, aspects of the present invention may be embodied as a system, method or computer program product. Accordingly, elements the present invention may take the form of hardware, software (including firmware, resident software, micro-code, etc.) or elements combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon. Any combination of one or more computer-readable medium(s) may be utilized. The computer-readable medium may be a computer-readable signal medium, a computer-readable storage medium, or a combination thereof.

As defined herein, the term “computer-readable storage medium” means a storage medium that contains or stores program code for use by or in connection with an instruction execution system, apparatus, or device. As defined herein, a “computer-readable storage medium” is not a transitory propagating signal per se. A computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object-oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

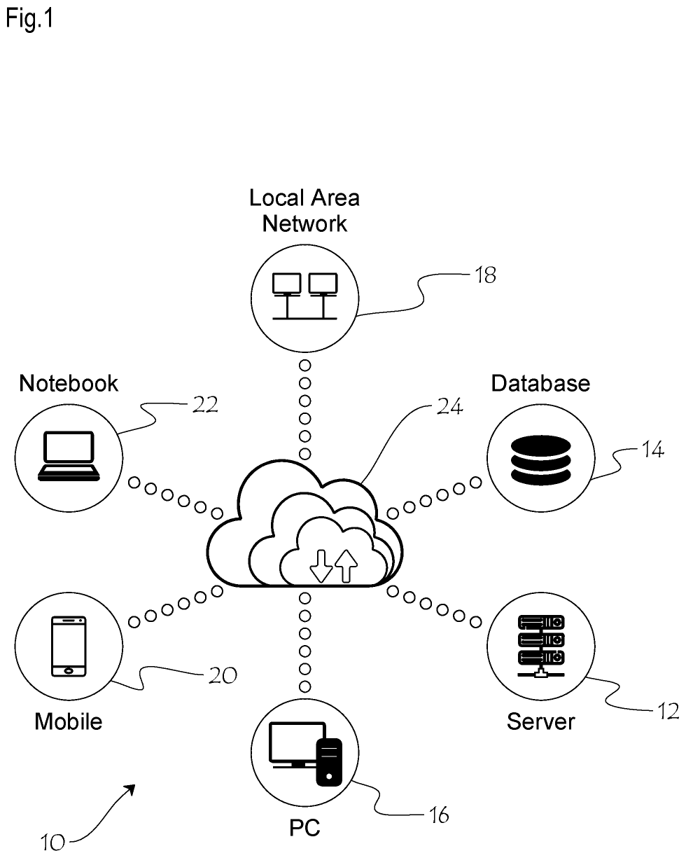

FIG. 1 shows a conventionally organized computer network environment 10 that is usable to operate the method, system and computer program product according to the present invention. Network environment 10 is illustrated to comprise a server 12 which may include one or more computers that comprises computer hardware and software that provides functionality for other programs or devices. Server 12 may provide various functionalities or services, such as sharing data or resources among multiple other computers and performing computations for other computers.

Network environment 10 further comprises a database 14 that comprises and allows an organized collection of data that is stored and accessed electronically from other authorized computers of network environment 10. A database management system that includes suitable software is provided to interact with end users, applications, and the database itself to capture and analyze the data in database 14.

Network environment 10 also comprises one or more client computer systems 16, 18, 20, 22. Client computer systems may include, but are not limited to, a single desktop personal computer 16, a number of personal computers linked into a local area network 18 through a network communication system, a cellular phone 20 or a portable computer 22.

Network environment 10 allows server 12, database 14 and client computer systems 16, 18, 20, 22 to communicate with each other through suitable common communication protocols over digital interconnections, enabled by suitable hardware and software. These interconnections comprise known telecommunication network technologies. In FIG. 1, the communication devices, software and other operating elements of network environment 10 that allows communication between server 12, database 14 and client computer systems 16, 18, 20, 22 is schematically shown as a network communication element 24, which may include either a private network or a public network such as the Internet. Different devices 12, 14, 16, 18, 20, 22 on network environment 10 may be allowed or disallowed to communicate for the purpose of carrying out the present invention, as detailed or inferred hereinafter, and as will be obvious to someone skilled in the art.

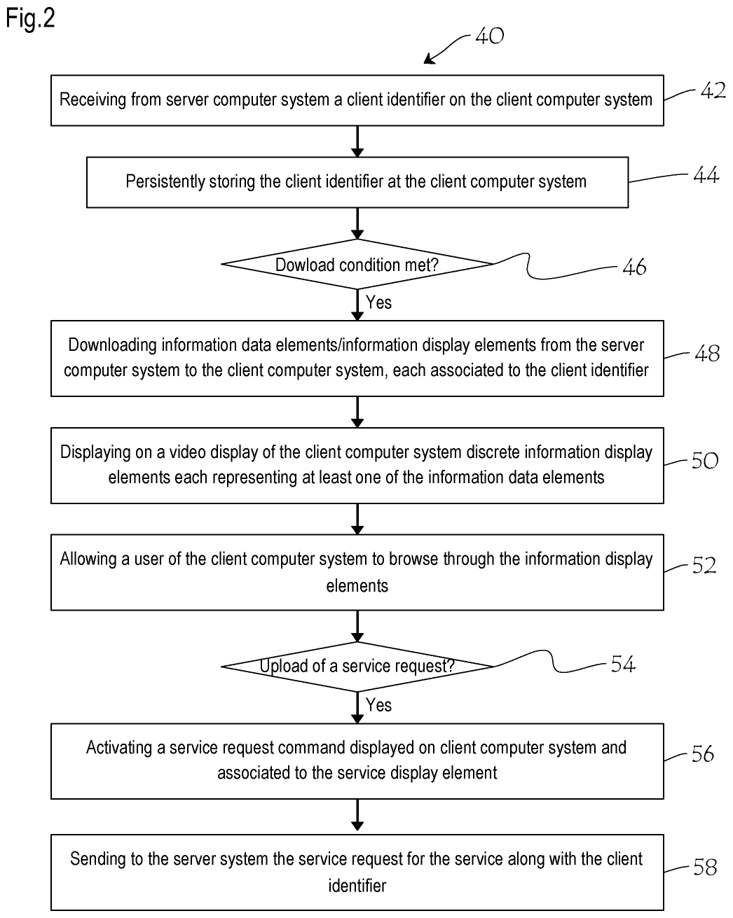

According to the present invention, network environment 10 allows to carry out a method 40 as shown in FIG. 2, of dispensing digital business concierge services on one or more client computer systems 16, 18, 20, 22. The method specifically targets the dispensation of digital business services in the field of managed digital marketing services. The method 40 comprises the steps of:
receiving from a server computer system a client identifier on the client computer system 42;
persistently storing the client identifier at the client computer system 44; and
when a download condition is met 46:
   downloading information data elements from the server computer system to the client computer system, each associated to the client identifier 48;
   displaying on a video display of the client computer system discrete information display elements each representing at least one of said number of information data elements 50;
   allowing a user of the client computer system to browse through the information display elements 52;
   at least some of the information display elements comprising respective service display elements; and
   for each said service display element displayed through said information display elements, allowing the user to upload a service request from the client computer system to the server computer system to order a service associated to the service display element 54, the upload of a service request comprising:
      activating a service request command displayed on client computer system and associated to the service display element 56; and
      sending to the server system the service request for the service along with the client identifier, the client identifier identifying account information previously supplied by the user of the client computer system 56, wherein the user does not need to log in to the server system when ordering the service.

The steps of receiving from the server computer system 12 a client identifier on the client computer system 16, 18, 20, 22 and persistently storing the client identifier at the client computer system 16, 18, 20, 22 are preceded by the user creating a user account on the server 12 to then receive the client identifier from the server 12 on the client computer system 16, 18, 20, 22 such that ulterior information uploaded to the server 12 with the client identifier may be linked to the user account on server 12. The user account information and client identifier may be stored in database 14, with suitable security measures to prevent unauthorized access thereto.

Persistently storing the client identifier on the client computer system includes possible modifications and updates to the client identifier. For instance, it is known to update client identifiers from time to time, to increase the security of the user account on server 12. Consequently, herein, reference to the “persistent” storing of a client identified does not mean that the client identified remains unchanged; just that, it is not just temporarily stored on the client computer system e.g. while a user account is created and then erased; rather, it remains stored on the client computer system for ulterior identification and authentication of the client account by means of the client identified.

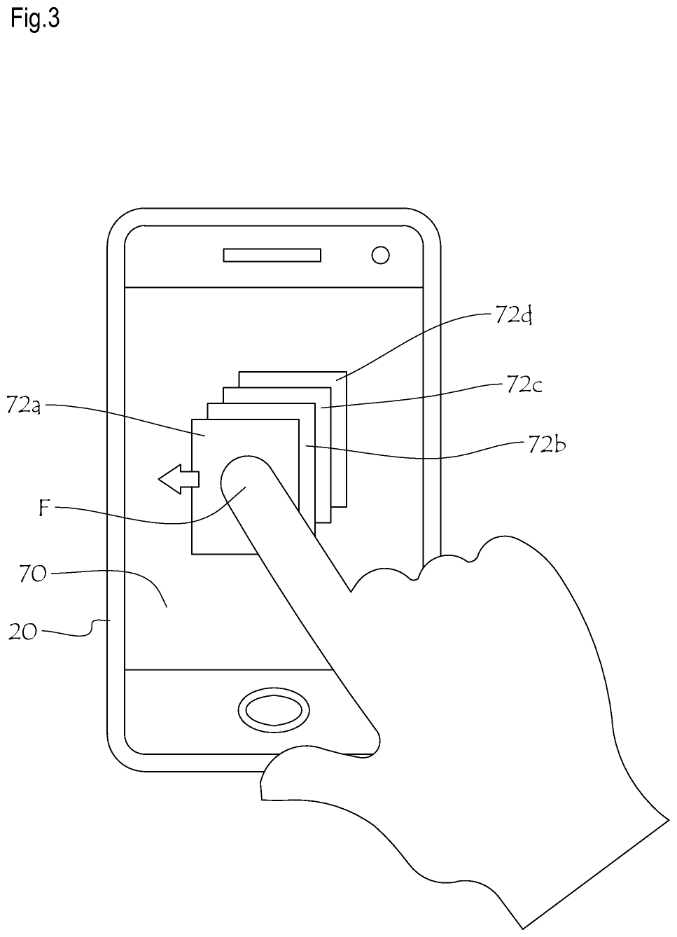

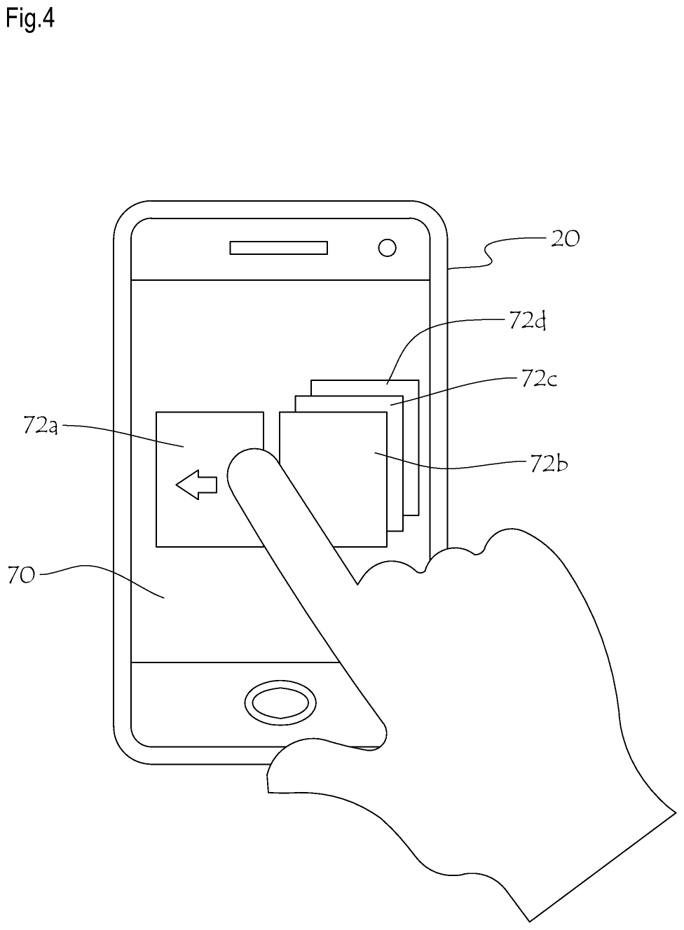

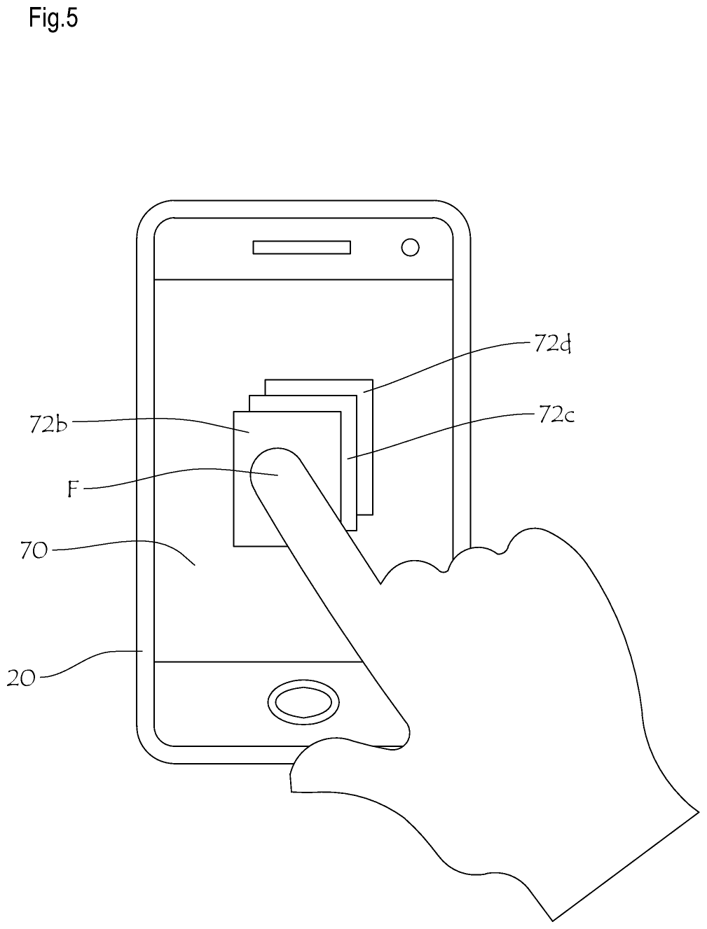

In one embodiment, as shown sequentially in FIGS. 3 to 5, the step of allowing a user of the client computer system 16, 18, 20, 22 to browse through the display elements, comprises the user swiping a touch screen 70 of the client computer system (here shown to be smart phone 20) with a finger F to switch between successive information display elements 72a, 72b, 72c, 72d, collectively referred to as information display elements 72, that are individually and successively displayed on the touch screen 70. The information display elements may include any number of discrete display elements 72 each in the form of card images wherein a corresponding information data element is displayed, with swiping the touch screen of the client computer system with a finger to switch between successive information display elements comprising switching from one card image to another. In FIG. 3 the user applies their finger F against the topmost card associated to the first listed information display element 72a. They then swipe their finger laterally as suggested by the arrows in FIGS. 3 and 4, whereby the topmost card 72a is moved on the screen away from the stack of other cards 72b, 72c, 72d, until it is disposed of, i.e. it is removed from the display area of screen 70, as suggested in FIG. 5 where only information display elements 72b, 72c, 72d remain.

In one alternate embodiment (not shown), the information display element that is swiped laterally 72a could be placed back under the stack of information display elements 72b, 72c, 72d, instead of being removed form the display area of screen 70 entirely.

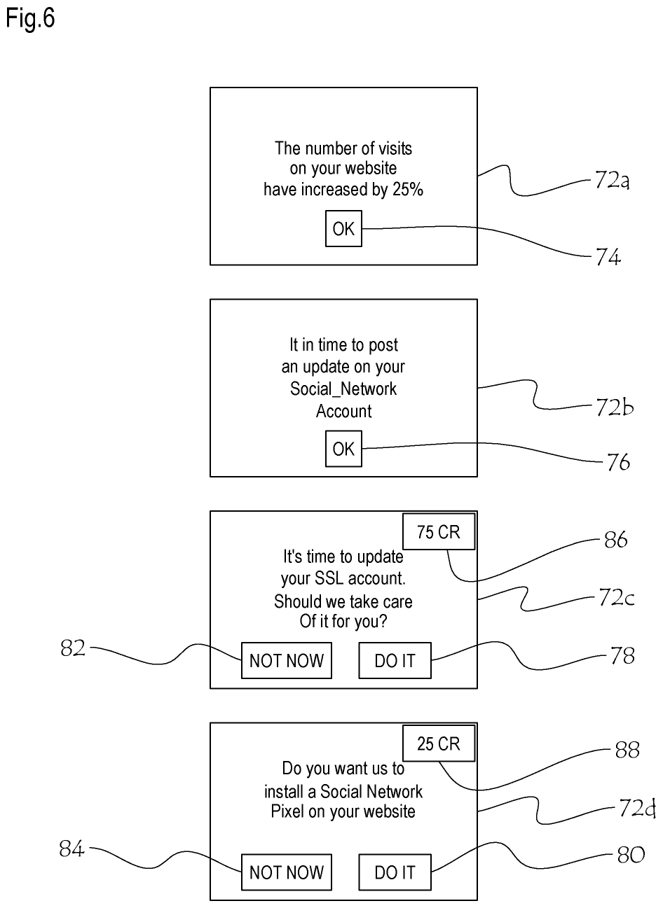

FIG. 6 shows exemplary information display elements 72a, 72b, 72c, 72d. Information display elements 72a and 72b offer information (72a) or a reminder (72b) to the user. When the information has been read by the user, they may either swipe the card away as indicated above, or press on the “OK” button 74, 76 provided on information display element 72, 72b, to dispose of the information display element 72a, 72b.

Information display elements 72c and 72d are service display elements that each allow the user to upload a service request from the client computer system 20 to the server computer system 12 to order a service associated to the service display element 72c, 72d. To do so, the user may, through a single command or sequence of commands (see below), initiate a request for a service by pressing a “DO IT” button 78, 80. The DO IT button 78, 80 consequently represents a service request command displayed on client computer system 20, each DO IT button 78, 80 respectively associated to one of service display elements 72c or 72d. Once the DO IT button 78 or 80 is pressed, the client computer system 20 will send to the server system the service request for the service along with the client identifier.

Herein, “a single command or sequence of commands” refers to the fact that the user need not recreate their user account or be redirected to a user account information page. Instead, since the client identified is used, the service request will be simply forwarded to the server. A sequence of commands may include for example pressing on the DO IT button 78, 80, then upon being asked for a confirmation that the service is indeed being requested, the user confirming that the service is indeed being requested.

If the user does not wish to order the service associated with a service display element 72c, 72d, they may laterally swipe the card associated thereto to dispose of the card or move it under the stack of cards, or press the “NOT NOW” button 82, 84.

In one embodiment, the client account associated with the client identifier that is created on the server computer system 12 and database 14 allows the user to store credits on their account in database 14. These credits may be purchased by the client and associated to their client account, such that the order of a service associated with the service display element entails debiting a determined number of credits from the client account. The number of credits associated with the purchase of a given service may be displayed on each service display element such as at 86, 88 on FIG. 6. The credits may be any suitable currency including a national currency, or a currency specific to the digital business concierge services that are dispensed to client computer systems 16, 18, 20, 22.

The download condition for downloading new information data display elements 72 to each client computer system 16, 18, 20, 22 may be a download trigger programmed at determined time intervals on the client computer system or on the server computer system 12. The download trigger then initiates the download of information data elements to client computer systems 16, 18, 20, 22.

Alternately, the download condition may be a punctual user-triggered request on client computer systems 16, 18, 20, 22 that initiates the download of the information data elements to said client computer system; or an administrator-triggered instruction on the server computer system 12 by an administrator of the server computer system 12.

In one embodiment, client computer systems 16, 18, 20, 22 use a web-based interface to communicate with the server computer system 12, while in another embodiment the client computer system downloads and uses a software-based application interface to communicate with the server computer system 12.

Once the service request is received at the server computer system 12, it may be automatically handled, such as forwarded to an appropriate service provider; or handled by an administrator of server computer system 12. The manner and process for providing the service to the user may vary depending on the service being requested.

1. A method of dispensing digital business concierge services on a client computer system, comprising:
receiving from a server computer system a client identifier on the client computer system;
persistently storing the client identifier at the client computer system; and
when a download condition is met:
downloading information data elements from the server computer system to the client computer system, each associated to the client identifier;
displaying on a video display of the client computer system discrete information display elements each representing at least one of said number of information data elements;
allowing a user of the client computer system to browse through the information display elements;
at least some of the information display elements comprising respective service display elements; and
for each said service display element displayed through said information display elements, allowing the user the upload of a service request from the client computer system to the server computer system to order a service associated to the service display element, triggering the upload of a service request comprising:
activating a service request command displayed on client computer system and associated to the service display element; and
sending to the server system the service request for the service along with the client identifier, the client identifier identifying account information previously supplied by the user of the client computer system wherein the user does not need to log in to the server system when ordering the service.

2. The method as defined in claim 1, wherein the step of allowing a user of the client computer system to browse through the display elements, comprises the user swiping a touch screen of the client computer system with a finger to switch between successive information display elements that are individually and successively displayed on the touch screen.

3. The method as defined in claim 1, wherein said download condition is a download trigger programmed at determined time intervals on said client computer system, said download trigger initiating the download of said information data elements to said client computer system.

4. The method as defined in claim 1, wherein said download condition is a punctual user-triggered request on said client computer system that initiates the download of said information data elements to said client computer system.

5. The method as defined in claim 1, wherein said download condition is an administrator-triggered instruction on said server computer system by an administrator of said server computer system, that initiates the download of said information data elements from the server computer system to said client computer system.

6. The method as defined in claim 1, wherein the client computer system is one of a portable computer device and a personal desktop computer.

7. The method as defined in claim 1, wherein the client computer system uses a web-based interface to communicate with the server computer system.

8. The method as defined in claim 1, wherein the client computer system uses a software-based application interface to communicate with the server computer system.

9. The method as defined in claim 2, wherein the discrete display elements are each in the form of card images wherein a corresponding information element is displayed, with swiping a touch screen of the client computer system with a finger to switch between successive information display elements comprising switching from one card image to another.

10. The method as defined in claim 1, wherein a client account associated with the client identifier is created on the server computer system, and credits may be purchased by the client and associated to their client account, such that the order of a service associated with the service display element entails debiting a determined number of credits from the client account.

11. The method as defined in claim 10, wherein the determined number of credits for the service being ordered is displayed on the associated service display element.

12. A client computer system comprising a processor programmed to initiate executable operations for dispensing digital business concierge services thereon, the executable operations comprising:
receiving from a server computer system a client identifier on the client computer system;
persistently storing the client identifier at the client computer system; and
when a download condition is met:
downloading from the server computer system a number of information data elements, with each of the number of information data elements being associated to the client identifier;
displaying on a video display of the client computer system discrete information display elements each representing at least one of said number of information data elements;
allowing a user of the client computer system to browse through the information display elements; and
at least one of the information display elements comprising a service display element, said service display element allowing the user to trigger the upload of a user request from the client computer system to the server computer system to order a service associated to the service display element;
wherein the step of allowing the user to trigger the upload of a user request from the client computer system to the server computer system comprises activating a command displayed on the service display element, sending to the server system the request for the service along with the client identifier, the client identifier identifying account information previously supplied by the user of the client computer system wherein the user does not need to log in to the server system when ordering the service.

13. A computer program product comprising a computer readable memory storing computer executable instructions thereon that when executed by a client computer system for dispensing digital business concierge services, perform the steps of:
receiving from a server computer system a client identifier on the client computer system;
persistently storing the client identifier at the client computer system; and
when a download condition is met:
downloading from the server computer system a number of information data elements, with each of the number of information data elements being associated to the client identifier;
displaying on a video display of the client computer system discrete information display elements each representing at least one of said number of information data elements;
allowing a user of the client computer system to browse through the information display elements; and
at least one of the information display elements comprising a service display element, said service display element allowing the user to trigger the upload of a user request from the client computer system to the server computer system to order a service associated to the service display element;
wherein the step of allowing the user to trigger the upload of a user request from the client computer system to the server computer system comprises activating a command displayed on the service display element, sending to the server system the request for the service along with the client identifier, the client identifier identifying account information previously supplied by the user of the client computer system wherein the user does not need to log in to the server system when ordering the service.
